(19) United States
(12) Patent Application Publication
(10) Pub. No.: US 2006/0162390 A1
(43) Pub. Date: Jul. 27, 2006

(54) Method and apparatus for sintering porous optical fiber preforms

(75) Inventors: Arnab Sarkar, West Hills, CA (US); Bedros Orchanian, North Hills, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(73) Assignee: Nextrom Oy

(21) Appl. No.: 11/316,323

(22) Filed: Dec. 21, 2005

Related U.S. Application Data
(60) Provisional application No. 60/638,881, filed on Dec. 23, 2004.
(60) Provisional application No. 60/644,226, filed on Jan. 13, 2005.

(51) Int. Cl. C03B 37/10; C03B 37/012

(52) U.S. Cl. 65/427; 65/507

(57) ABSTRACT

An improved method and apparatus is disclosed for sintering large, cylindrical, porous bodies used in the manufacture of high-quality optical fiber preforms. The apparatus has a compact, simplified structure, as compared to comparable apparatus of the prior art. The apparatus includes two separate support/slide assemblies that support the porous body throughout the sintering process. A first support/slide assembly engages a special handle for the porous body during a first stage of the process, in which the body is lowered into a furnace muffle. A second support/slide assembly then engages the porous body's handle during a second stage of the process, in which the body is controllably moved through a hot zone of the furnace, for dehydration and sintering of the body into a dense glass optical fiber preform. The body's handle is specially configured to allow both support/slide assemblies to be engaged with it simultaneously, whereby the sintering process can be carried out without the need for separate support structure during the switchover from the first support/slide assembly to the second support/slide assembly.

### CROSS-REFERENCE TO RELATED APPLICATION

Priority is claimed under 35 U.S.C. § 119(e) to U.S. Provisional Patent Application No. 60/638,881, filed on Dec. 23, 2004, entitled “Method and Apparatus for Sintering Porous Optical Fiber Preforms,” by Arnab Sarkar, and Bedros Orchanian, and to U.S. Provisional Patent Application No. 60/644,226, filed on Jan. 13, 2005, entitled “Method and Apparatus for Sintering Porous Optical Fiber Preforms,” by Arnab Sarkar and Bedros Orchanian, which applications are incorporated by reference herein.

### BACKGROUND OF THE INVENTION

1. Field of the Invention

This invention relates generally to the sintering or densification of porous soot bodies produced by a flame hydrolysis process, for manufacturing optical fiber preforms of high-quality silica glass, and, more particularly, to methods and apparatus for efficiently sintering porous soot bodies of a very large size.

2. Description of Prior Art

The basic flame hydrolysis process is described in U.S. Pat. No. 2,272,342, which issued in 1942 to J. Hyde. Two alternative processes for producing such porous bodies have been described in detail in chapters 2 and 3 of a book entitled “Optical Communications, Volume 1, Fiber Fabrication,” edited by Tingye Li (1985). Before the porous bodies can be drawn into high-quality, single-mode optical fibers, the bodies must be sintered into dense glass preforms. Such sintering is described in these same chapters, and also in U.S. Pat. No. 4,338,111, which issued in 1983 to T. Edahiro et al. In the sintering process, the porous body is dehydrated and densified in a controlled atmosphere, at high temperature, into a fully dense glass body.

Typically, sintering is performed using a sintering furnace that includes an elongated quartz muffle having a narrow hot zone. After the porous body has been placed in an upper portion of the muffle, above the hot zone, the muffle is filled with helium or a helium/chlorine mixture and the temperature of the hot zone is raised to a suitable value, e.g., about 1500° C. The porous body then is slowly fed through the furnace's hot zone, to consolidate the porous body into a dense glass preform.

FIG. 1 is a schematic diagram depicting one example of a prior art sintering apparatus commonly used in the past. The apparatus includes a sintering furnace 11 that encloses an elongated, vertically oriented quartz muffle 13 having a hot zone 15 at its mid-portion, surrounded by heaters 17. The apparatus is used to sinter a cylindrical, porous soot body 19 having a quartz glass handle 21 projecting from its upper end. The handle is configured to include an enlarged, spherical ball (not shown) that can be held by a socket 23 that is part of a preform holder 25. The holder is fused to a quartz glass push rod 27, which, in turn, is held in a chuck 29, or similar suitable fixture. The chuck is movable upward and downward on a vertical slide 31.

FIG. 1 shows the sintering apparatus at five successive stages (Stages A-E) of the sintering process. In Stage A, the apparatus's components are located at the starting position of the sintering process. In this position, the preform holder 25 supports the porous soot body 19 in a vertical position above the sintering furnace's quartz muffle 13. In Stage B, the preform holder and porous soot body have been lowered into the quartz muffle. A dynamic seal (not shown in the Figure) located at the muffle's upper end seals around the push rod 27, to prevent ambient air from entering the muffle. At this time, the porous body remains positioned above the furnace's hot zone 15, the temperature of the muffle's hot zone is maintained at a suitable value, e.g., 1500° C., and the muffle's interior is filled with a controlled atmosphere of specific gases, e.g., helium or a helium/chlorine mixture.

Next, to dehydrate and sinter the porous soot body 19, the chuck 29 rotates the body about its longitudinal axis and slowly lowers the body through the furnace's hot zone 15. This dehydrates and sinters the body into a bubble-free, clear glass preform having a length and diameter substantially reduced from that of the original porous body. The depiction in FIG. 1 of Stage C of the process shows the glass preform 19 after it has been moved fully through the hot zone.

In Stages D and E of the sintering process, also depicted in FIG. 1, the sintered preform 19 has been raised to the upper portion of the quartz muffle 13 (Stage D) and fully out of the muffle (Stage E).

The sintering apparatus depicted in FIG. 1 has been used widely because of its simplicity; however, it suffers from the inherent drawback of requiring an equipment frame having a height that is at least four times the length of the original porous soot body 19, plus the distance from the top of the porous body to the bottom of the push rod 27.

U.S. Pat. No. 5,423,898, which issued in 1995 to M. Terashima et al. (the Terashima patent), describes one approach for reducing the height of the sintering apparatus. The Terashima approach allows the overall height of the apparatus to be reduced by an amount corresponding to the length of one porous soot body. This reduction provides a significant cost saving, not only for the equipment, but also for the cost of the factory building that houses the equipment.

FIG. 2 of the drawings depicts an improved apparatus substantially similar to that disclosed in the Terashima patent. The apparatus includes two vertical slides 33 and 35 and two horizontal slides 37 and 39, for supporting a chuck 41 that, in turn, supports a quartz glass push rod 43. A quartz glass preform holder 45 is fused to the lower end of the push rod, and it, in turn, supports a quartz glass handle 47 on which is deposited a porous soot preform 49. The chuck 41 moves up and down on the vertical slide 33. The apparatus further includes a second preform holder 51 mounted on the second horizontal slide 39 and a clamping mechanism 53 that holds the handle 47 while the preform holders 45 and 51 are exchanged.

FIG. 2 shows the sintering apparatus at seven successive stages (Stages A-G) of the sintering process. In Stage A, the apparatus's components are located at the starting position of the sintering process. In this position, the horizontal slide 39 and the vertical slide 35 are positioned such that the preform holder 45 supports the porous soot body 49 in a vertical position above a sintering furnace's quartz muffle 55. At this time, the push rod 43 is held off-axis, on the horizontal slide 37 and the vertical slide 33.

In Stage B, the porous soot body 49 has been lowered into an upper portion of the quartz muffle 55, above the muffle's hot zone 57. At this time, the body is clamped in place by the clamping mechanism 53 that engages the preform handle 47. Thereafter, in Stage C, the preform holder 45 has disengaged from the preform handle 47 and moved horizontally off-axis on the horizontal slide 39. The push rod 43 then is moved on-axis along the horizontal slide 37, until it has engaged the preform handle 47. After this switchover has been completed, the clamping mechanism 53 is disengaged and removed. At this time (Stage C), the muffle 55 can be closed, the sintering environment can be replaced by the desired gases, the furnace can be heated to the desired temperature, and the preform holder 51 can begin to move downward on the vertical slide 33, to controllably move the soot body 49 through the muffle's hot zone 57.

In Stage D of the sintering process, the soot body 49 has moved fully past the muffle's hot zone 57, which has dehydrated and sintered the body into a dense glass preform. Thereafter, Stages E, F, and G of the sintering process are the successive positions for removing the sintered preform 49. It will be appreciated that the Terashima sintering apparatus has an overall height that is less than that of the sintering apparatus of FIG. 1 by an amount corresponding to length of one porous soot body.

The sintering apparatus disclosed in the Terashima patent includes two separate drives, located on two separate loading spindles, both having two-axis drive capability. The apparatus also requires a clamping device 53 for clamping onto the preform handle 47 while support for the porous body 49 is transferred between the first holder 45 and the second holder 51. The handle typically is fabricated of quartz glass, and its location within the muffle 55 can cause it to be quite hot. Consequently, the clamping device can degrade with use and it can damage the quartz handle. This, in turn, can possibly lead to a catastrophic accident in which the preform falls within the muffle.

It should, therefore, be appreciated that there remains a need for an improved sintering apparatus and method for sintering large, cylindrical porous soot bodies, which retains the reduced equipment height of the apparatus disclosed in the Terashima patent, but which also includes a simplified, less expensive structure for loading and unloading the porous soot bodies. The present invention fulfills this need and provides further related advantages.

### SUMMARY OF THE INVENTION

The present invention resides in an improved sintering apparatus and method for sintering a cylindrical, porous bodies in a simplified and more cost-effective manner. The apparatus is particularly configured to sinter porous bodies of a kind having a handle projecting from their upper end and including first and second engagement sections. The apparatus includes (1) a sintering furnace having an elongated, vertically oriented muffle sized and configured to receive the cylindrical, porous body, the muffle being including a hot zone for sintering the body as the body is controllably moved through it; (2) a first support/slide assembly for engaging the body handle's first engagement section and supporting the porous body in a vertical orientation above the muffle of the sintering furnace, and thereafter for lowering the body into the muffle of the sintering furnace; and (3) a second support/slide assembly for engaging the body handle's second engagement section, while the first support/slide assembly continues to engage the body handle's first engagement section, after which the first support/slide assembly can disengage from the first engagement section, whereupon the second support/slide assembly supports the porous body in a vertical orientation within the muffle and thereafter controllably lowers the body through the hot zone of the muffle such that the body is dehydrated and sintered into a dense glass preform. Throughout the sintering process, the porous body is supported by the first support/slide assembly and/or the second support/slide assembly, without the need for any supplemental support structure.

In other, more detailed features of the invention, the body handle is elongated and formed of quartz, and its two engagement sections are defined by enlargements, e.g., spherical balls, and the two support/slide assemblies each include a socket sized and configured to releasably engage its corresponding enlargement. The two enlargements are spaced sufficiently apart from each other to allow them to be engaged by the two support/slide assemblies simultaneously.

In yet other, more detailed features of the invention, the two support/slide assemblies each include (1) a handle support configured to engage one of the body handle's engagement sections; (2) a horizontal slide attached to the handle support and configured to controllably position the handle support at a selected horizontal position; and (3) a vertical slide attached to the horizontal slide and configured to controllably position the handle support at a selected vertical position.

In an alternative embodiment of the invention, the horizontal and vertical slides of the first support/slide assembly are substituted by a transport assembly attached to the first handle support and configured to controllably position the first handle support at a selected horizontal and vertical position.

Other features and advantages of the present invention should become apparent from the following description of the preferred embodiments, taken in conjunction with the accompanying drawings, which illustrate, by way of example, the principles of the invention.

### BRIEF DESCRIPTION OF THE DRAWINGS

FIG. 1 is a schematic drawing of a prior art sintering apparatus for dehydrating and sintering a large porous soot body, the apparatus schematically depicting five successive stages A-E of the sintering process.

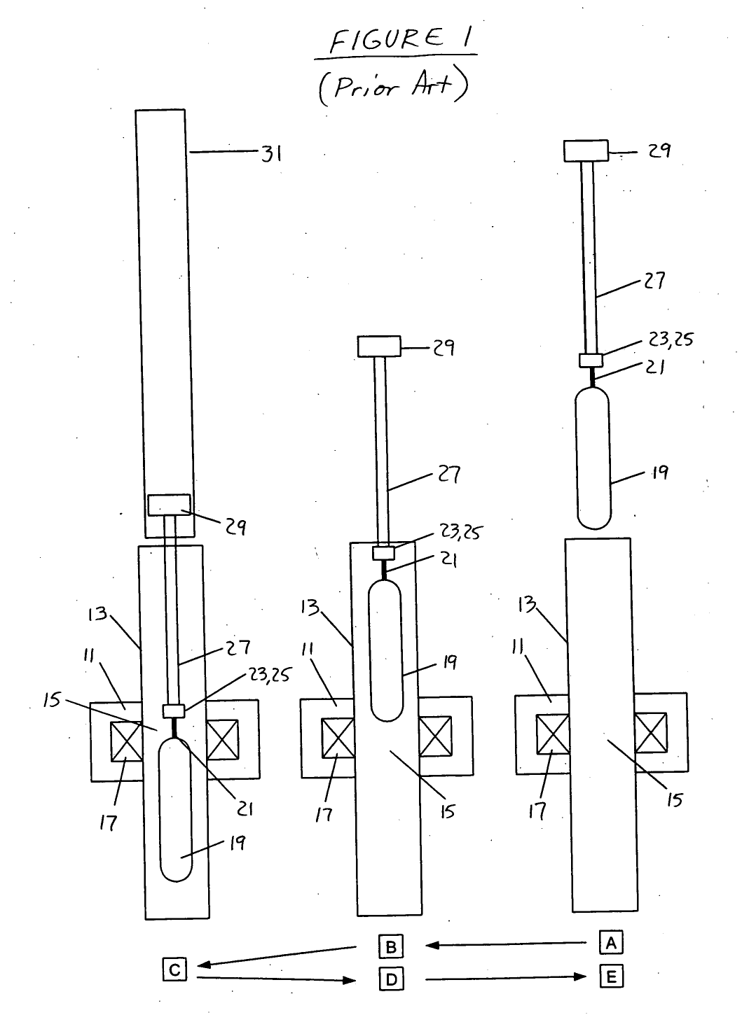

FIG. 2 is a schematic drawing of a prior art sintering apparatus similar to that disclosed in U.S. Pat. No. 5,423,898 to Terashima et al., for dehydrating and sintering a large porous soot body, the apparatus schematically depicting seven successive stages A-G of the sintering process.

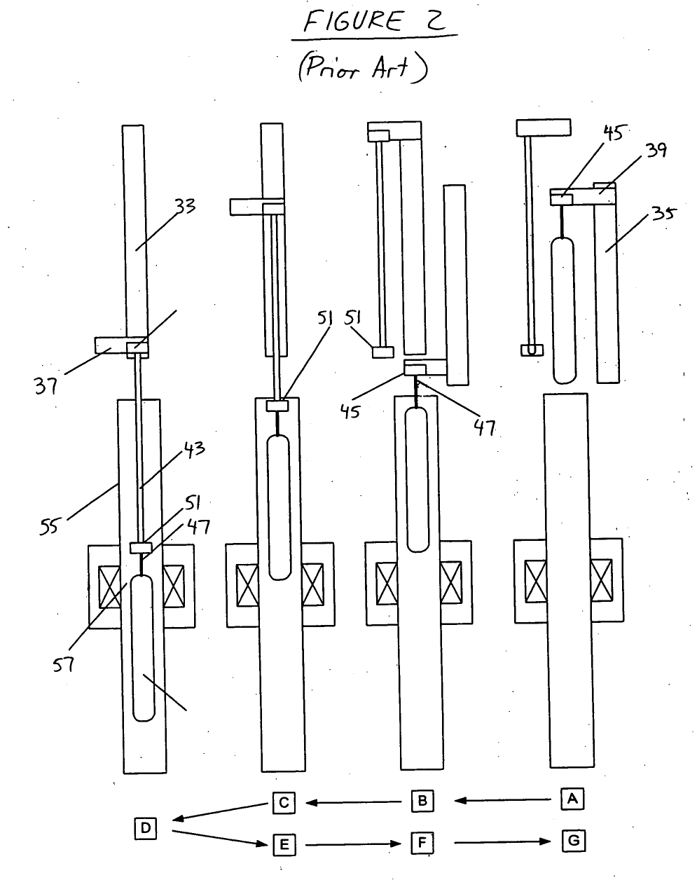

FIG. 3 is a schematic drawing of a sintering apparatus in accordance with a preferred embodiment of the invention, for dehydrating and sintering a large porous soot body, the apparatus schematically depicting seven successive stages A-G of the sintering process.

FIG. 4 is a schematic drawing, not to scale, of the preform handle and the first and second sockets for engaging the handle included in the sintering apparatus of FIG. 3.

FIG. 5 is a schematic drawing of a sintering apparatus in accordance with an alternative preferred embodiment of the invention, for dehydrating and sintering a large porous soot body, the apparatus schematically depicting seven successive stages A-G of the sintering process.

### DESCRIPTION OF THE PREFERRED EMBODIMENTS

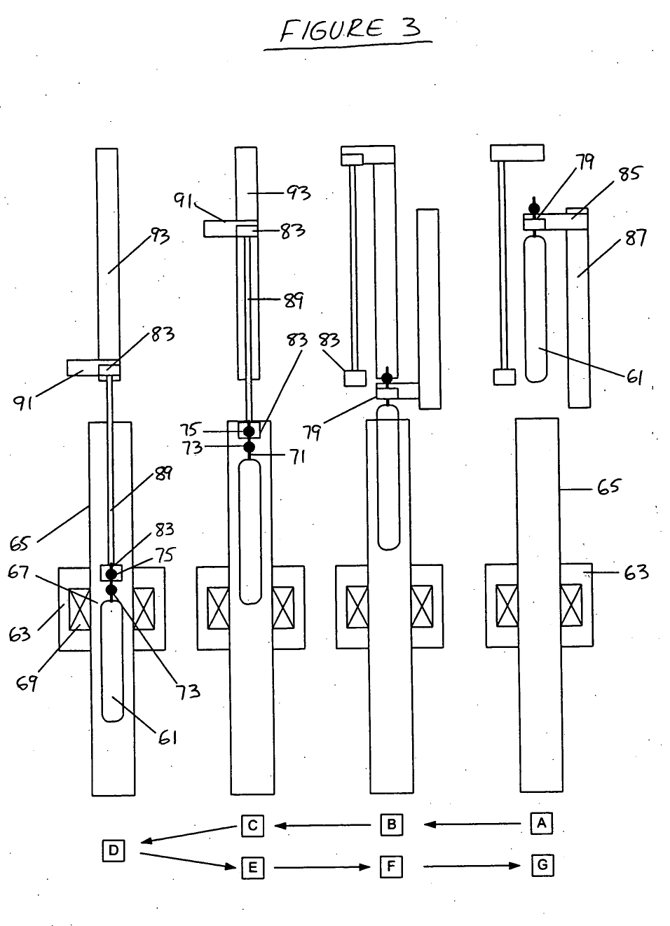

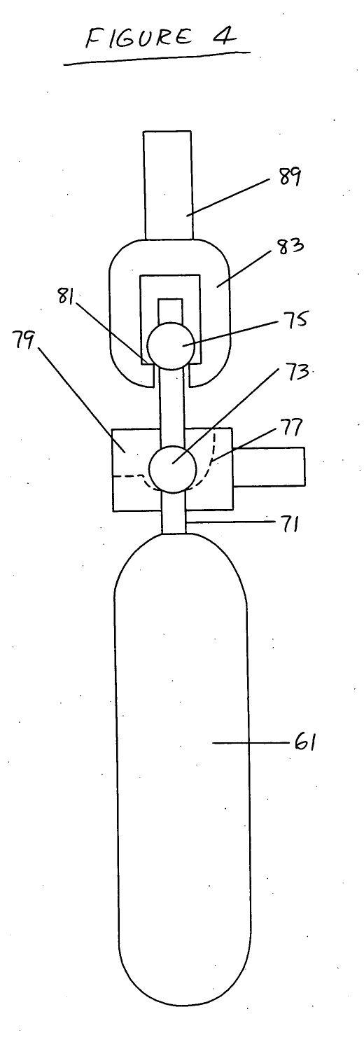

With reference now to the exemplary drawings, and particularly to FIGS. 3 and 4, there is shown a sintering apparatus for dehydrating and sintering a large, cylindrical, porous soot body 61, with reduced equipment cost and complexity. The apparatus includes a sintering furnace 63 that encloses an elongated, vertically oriented quartz muffle 65 having a hot zone 67 at its mid-portion, surrounded by heaters 69. A closable cap (not shown in the Figure) is located at the muffle's upper end. A special quartz glass handle 71 projecting upward from the soot body's upper end is configured to include two enlarged, spherical balls 73 and 75, one above the other. The lower ball 73 is configured to be engaged and supported by a socket 77 that is part of a first preform holder 79, and the upper ball 75 is configured to be engaged and supported by a socket 81 that is part of a second preform holder 83. The first preform holder 79 is mounted on a first horizontal slide 85, which in turn is mounted on a first vertical slide 87. The second preform holder 83 is fused to the lower end of a quartz glass push rod 89, the upper end of which is mounted on a second horizontal slide 91, which in turn is mounted on a second vertical slide 93.

The spherical balls 73 and 75 of the preform handle 71 and the respective first and second sockets 77 and 81 form special ball-and-socket configurations. The socket 77 has a vertical orientation, and the socket 81 has a horizontal orientation. The two balls are spaced sufficiently apart from each other to allow the two sockets to engage the balls simultaneously.

FIG. 3 shows the sintering apparatus at seven successive stages (Stages A-G) of the sintering process. In Stage A, the apparatus's components are located at the starting position of the sintering process. In this position, the first preform holder 79 engages and supports the lower spherical ball 73 of the preform handle 71. The first horizontal slide 85, which supports the first preform holder 79, is positioned at the upper end of the first vertical slide 87, such that the porous soot body 61 is positioned vertically above the sintering furnace's quartz muffle 65. At this stage of the process, the second preform holder 83 and its associated second horizontal slide 91 and second vertical slide 93 are retracted laterally off-axis, away from the soot body.

In Stage B of the sintering process, the first horizontal slide 85, and thus the first preform holder 79, have been lowered to the lower end of the first vertical slide 87. This moves the porous soot body 61 downward into the upper portion of the quartz muffle 65. At this time, the second horizontal slide 91 moves laterally, to bring the second preform holder 83 into engagement with the upper spherical ball 75 of the preform handle 71. After this engagement has been completed, the first horizontal slide 85 moves laterally, to disengage the first preform holder 79 from the preform handle's lower spherical ball 73.

Thereafter, in Stage C of the sintering process, the second horizontal slide 91 moves downward on the second vertical slide 93, to lower the porous soot body 61 further into the quartz muffle 65, but still above the muffle's hot zone 67. A dynamic seal (not shown in the Figure) located at the muffle's upper end then seals around the push rod 89, to exclude ambient air from the muffle. At this time, the temperature of the muffle's hot zone is heated to a suitable value (e.g., 1500° C.), and the muffle's interior is filled with a controlled atmosphere of specific sintering gases, e.g., helium or a helium/chlorine mixture.

After the atmosphere of the quartz muffle 65 has been filled with the desired sintering gases and the temperature of the muffle's hot zone 67 has reached the desired value, the porous soot body 61 is controllably lowered through the hot zone by sliding the push rod 89 and second preform holder 83 downward on the second vertical slide 93. Stage D of FIG. 3 depicts the soot body after it has been moved almost entirely through the hot zone. This dehydrates and sinters the body into a dense glass preform.

Thereafter, Stages E, F, and G of FIG. 3 depict the positions of the components as the dense glass preform 61 is removed from the sintering apparatus. This removal basically involves a reversal of the steps performed in Stages A, B, C, and D.

The sintering apparatus of FIG. 3 substantially improves on the sintering apparatus of the Terashima patent, identified above. Specifically, it eliminates the need for a separate clamping mechanism while support of the porous soot body 61 is being transferred between the two preform holders 79 and 83. The apparatus thereby provides improved reliability and ease of automation, without increasing the apparatus's overall height.

Those skilled in the art will appreciate that the quartz balls 73 and 75 of the quartz preform handle 71 can be manufactured conveniently and inexpensively on a glass lathe. Those skilled in the art also will appreciate that alternative two-position handle configurations could be used in place of a dual ball and socket-type configuration. For example, a handle having two vertically separated holes could be used. Alternatively, the bottom of the push rod could be modified to have a tubular configuration, with two identical holes that could be engaged by quartz pins inserted across the tube and the preform handle. Those skilled in the art will appreciate that such a modified two-position handle configuration also could simplify automated preform handling and storage within a factory.

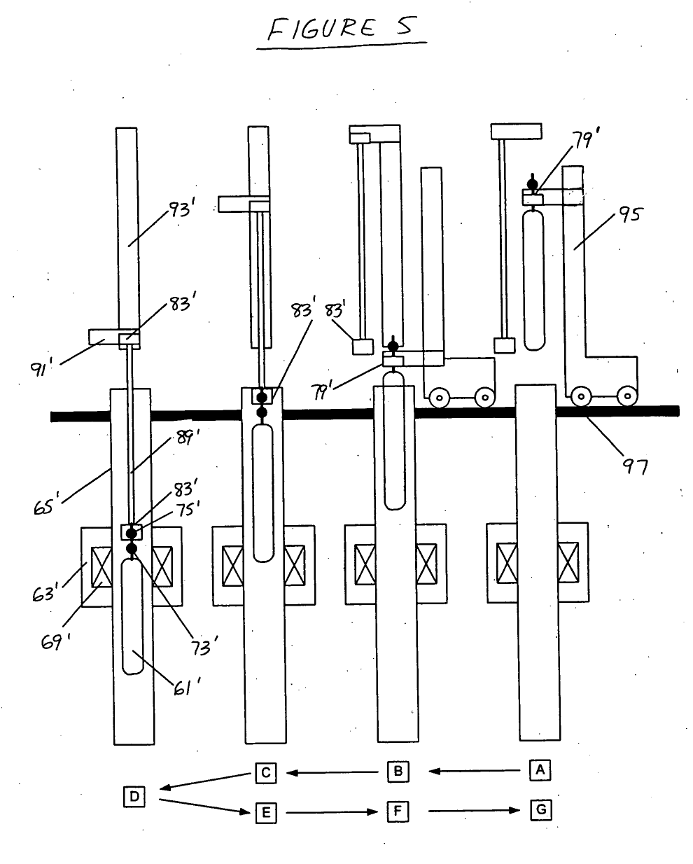

FIG. 5 shows an alternative embodiment of a sintering apparatus in accordance with the invention. This embodiment is substantially similar to the embodiment of FIG. 3, and similar components are identified by the same reference numerals, but accompanied by prime markings. The FIG. 5 embodiment differs from the FIG. 3 embodiment in that the first vertical slide 33 is replaced by a preform transport system 95 that moves along a raised platform or floor 97, just below the top of quartz muffle 65′. The horizontal slide 85′, which mounts the preform holder 83′, is mounted on the transport system 95. The transport system incorporates a precision positioning system, so that it can precisely lower the horizontal slide 85′, and thereby the soot body 61′, into the muffle 65′. This alternative embodiment further reduces sintering system cost, by eliminating the first vertical slide 33, although it requires a factory design having a raised floor 97 on which transport system 95 can move about.

Although the invention has been described in detail with reference only to the presently preferred embodiments, those skilled in the art will appreciate that various modifications can be made without departing from the invention. Accordingly, the invention is defined only by the following claims.

We claim:

1. Apparatus for sintering a cylindrical, porous body of a kind having a handle projecting from its upper end, the handle including first and second engagement sections, the apparatus comprising:
a sintering furnace having an elongated, vertically oriented muffle sized and configured to receive the cylindrical, porous body, the muffle being including a hot zone for sintering the body as the body is controllably moved through it;
a first support/slide assembly for engaging the body handle's first engagement section and supporting the porous body in a vertical orientation above the muffle of the sintering furnace, and thereafter for lowering the body into the muffle of the sintering furnace; and
a second support/slide assembly for engaging the body handle's second engagement section, while the first support/slide assembly continues to engage the body handle's first engagement section, after which the first support/slide assembly can disengage from the first engagement section, whereupon the second support/slide assembly supports the porous body in a vertical orientation within the muffle and thereafter controllably lowers the body through the hot zone of the muffle such that the body is dehydrated and sintered into a dense glass preform;
wherein, throughout the sintering process, the porous body is supported by the first support/slide assembly and/or the second support/slide assembly, without the need for any supplemental support structure.

2. Apparatus as defined in claim 1, wherein:
the body handle is elongated and includes a first enlargement that defines the first engagement section and a second enlargement that defines the second engagement section;
the first support/slide assembly includes a socket sized and configured to releasably engage the first enlargement of the body handle; and
the second support/slide assembly includes a socket sized and configured to releasably engage the second enlargement of the body handle.

3. Apparatus as defined in claim 2, wherein the first and second enlargements are spaced sufficiently apart from each other to allow the second support/slide assembly to engage the second enlargement without interference by the first support/slide assembly.

4. Apparatus as defined in claim 2, wherein:
the body handle is elongated and formed of quartz; and
the first and second enlargements that define the respective first and second engagement sections of the elongated body handle each have a generally spherical shape.

5. Apparatus as defined in claim 4, wherein:
the first support/slide assembly includes a socket sized and configured to conformably mate with and support the generally spherical ball that defines the body handle's first engagement section; and
the second support/slide assembly includes a socket sized and configured to conformably mate with and support the generally spherical ball that defines the body handle's second engagement section.

6. Apparatus as defined in claim 1, wherein the first and second support/slide assemblies each include:
a handle support configured to engage one of the body handle's engagement sections;
a horizontal slide attached to the handle support and configured to controllably position the handle support at a selected horizontal position; and
a vertical slide attached to the horizontal slide and configured to controllably position the handle support at a selected vertical position.

7. Apparatus as defined in claim 1, wherein:
the first support/slide assembly includes
a first handle support configured to engage the body handle's first engagement section, and
a transport assembly attached to the first handle support and configured to controllably position the first handle support at a selected horizontal and vertical position; and
the second support/slide assembly includes
a second handle support configured to engage the body handle's second engagement section,
a second horizontal slide attached to the second handle support and configured to controllably position the second handle support at a selected horizontal position, and
a second vertical slide attached to the second horizontal slide and configured to controllably position the second handle support at a selected vertical position.

8. A method for sintering a cylindrical porous body, comprising:
providing a body handle that projects upward from the cylindrical porous body and that includes first and second engagement sections spaced apart from each other;
providing a sintering furnace having an elongated, vertically oriented muffle sized and configured to receive the cylindrical porous body, the muffle including a hot zone for sintering the porous body as the body is controllably moved through it;
providing first and second support/slide assemblies, each assembly configured to engage one of the body handle's first and second engagement sections and thereafter to support the body in a vertical orientation and controllably lower the body within the muffle of the sintering furnace;
engaging the first support/slide assembly with the first engagement section of the body handle while the porous body is positioned above the muffle;
operating the first support/slide assembly so as to lower the porous body into the muffle;
engaging the second support/slide assembly with the second engagement section of the body handle and subsequently disengaging the first support/slide assembly from the body handle's first engagement section; and
operating the second support/slide assembly so as to lower the porous body through the muffle's hot zone, to dehydrate and sinter the porous body and thereby form a dense glass preform
wherein, throughout the sintering process, the porous body is supported by the first support/slide assembly and/or the second support/slide assembly, without the need for any supplemental support structure.

9. A method as defined in claim 8, wherein:
the body handle is elongated and includes a first enlargement that defines the first engagement section and a second enlargement that defines the second engagement section;
the first and second support/slide assemblies each include a socket sized and configured to releasably engage the respective first and second enlargements of the body handle; and
the sockets of the first and second support/slide assemblies are engageable with the respective first and second enlargements of the body handle by moving laterally into alignment with the enlargements.

10. A method as defined in claim 9, wherein the first and second enlargements of the body handle are spaced sufficiently far apart that socket of the second support/slide assembly can move laterally into alignment with the second enlargement of the body handle while the socket of the first support/slide assembly is engaged with the first enlargement of the body handle, without interference by the first support/slide assembly.

11. A method as defined in claim 8, wherein the first and second support/slide assemblies are configured such that they each can support the entire mass of the porous body.
